(19) United States
(12) Patent Application Publication
(10) Pub. No.: US 2020/0074040 A1
(43) Pub. Date: Mar. 5, 2020

(54) HIERARCHICAL EXPRESSION COVERAGE CLUSTERING FOR DESIGN VERIFICATION

(71) Applicant: Mentor Graphics Corporation, Wilsonville, OR (US)

(72) Inventor: Mennatallah Amer, Cairo (EG)

(21) Appl. No.: 16/119,921

(22) Filed: Aug. 31, 2018

(51) Int. Cl. G06F 17/50

(52) U.S. Cl. CPC G06F 17/5081; G06F 17/5045

(57) ABSTRACT

This application discloses performing functional verification on a circuit design describing an electronic device and a computing system to detect a pattern in a subset of expressions within a circuit design describing an electronic device, generate a merged expression from the subset of the identified expressions corresponding to the detected pattern, generate a hierarchical representation of the expressions based, at least in part, on the merged expression, and generate an expression coverage presentation based on the hierarchical representation of the expressions and the coverage data. The computing system can generate the expression coverage presentation by incorporating the merged expression into the expression coverage presentation and organizing the expressions and the merged expression in the expression coverage presentation by grouping the subset of the expressions utilized to generate the merged expression in the expression coverage presentation.

### TECHNICAL FIELD

This application is generally related to electronic design automation and, more specifically, to hierarchical coverage clustering for design verification.

### BACKGROUND

Designing and fabricating electronic systems typically involves many steps, known as a “design flow.” The particular steps of a design flow often are dependent upon the type of electronic system to be manufactured, its complexity, the design team, and the fabricator or foundry that will manufacture the electronic system from a design. Typically, software and hardware “tools” verify the design at various stages of the design flow by running simulators and/or hardware emulators, or by utilizing formal techniques, allowing any errors in the design discovered during the verification process to be corrected.

Initially, a specification for a new electronic system can be transformed into a logical design, sometimes referred to as a register transfer level (RTL) description of the electronic system. With this logical design, the electronic system can be described in terms of both the exchange of signals between hardware registers and the logical operations that can be performed on those signals. The logical design typically employs a Hardware Design Language (HDL), such as System Verilog or Very high speed integrated circuit Hardware Design Language (VHDL).

The logic of the electronic system can be analyzed to confirm that it will accurately perform the functions desired for the electronic system, sometimes referred to as “functional verification.” Design verification tools can perform functional verification operations, such as simulating, emulating, and/or formally verifying the logical design. For example, when a design verification tool simulates the logical design, the design verification tool can provide transactions or sets of test vectors, for example, generated by a simulated test bench, to the simulated logical design. The design verification tools can determine how the simulated logical design responded to the transactions or test vectors, and verify, from that response, that the logical design describes circuitry to accurately perform functions.

The design verification tools also can quantify how well the test vectors input to a logical design under verification came to covering or adequately exercising the logical design. Traditional techniques to determine coverage of the logical design include code coverage, such as statement coverage, branch coverage, decision coverage, condition coverage, expression coverage, toggle coverage, or the like, can identify which code lines, code statements, code expressions, code decisions, or toggles of the logical design were exercised by the test bench during verification operations. Specifically, the design verification tool can associate bins to count when different portions of the logical design under verification were exercised, and generate coverage lists corresponding to the counted totals in those bins.

Typically, the verification engineers review the overage lists to determine new sets of test vectors to provide to the logical design under verification, which could exercise the portions of the logical design under verification previously uncovered. These coverage lists can often be confusing, causing design teams to rely on human expertise to determine which portions of the design to attempt to exercise next and which portions to manually exclude from a coverage requirement. This reliance on human expertise often leads to inefficient test generation, long runtimes, in part due, to an increased reliance on time-intensive and resource-intensive formal verification to achieve coverage closure.

### SUMMARY

This application discloses performing functional verification on a circuit design describing an electronic device and a computing system to detect a pattern in a subset of expressions within a circuit design describing an electronic device, generate a merged expression from the subset of the identified expressions corresponding to the detected pattern, generate a hierarchical representation of the expressions based, at least in part, on the merged expression, and generate an expression coverage presentation based on the hierarchical representation of the expressions and the coverage data. The computing system can generate the expression coverage presentation by incorporating the merged expression into the expression coverage presentation and organizing the expressions and the merged expression in the expression coverage presentation by grouping the subset of the expressions utilized to generate the merged expression in the expression coverage presentation. Embodiments will be described in greater detail below.

### DESCRIPTION OF THE DRAWINGS

FIGS. 1 and 2 illustrate an example of a computer system of the type that may be used to implement various embodiments.

FIGS. 3A and 3B illustrate an example coverage data system storing coverage data from multiple verification tools that may be implemented according to various embodiments.

FIG. 4 illustrates an example coverage analysis tool 400 to generate an extracted pattern hierarchy from coverage data recorded during circuit design verification, which may be implemented according to various embodiments.

FIG. 5 illustrates an example expression coverage presentation based on an extracted pattern expression hierarchy which may be implemented according to various embodiments.

FIG. 6 illustrates an example flowchart implementing extracted pattern hierarchy generation from coverage data recorded during circuit design verification which may be implemented according to various embodiments.

### DETAILED DESCRIPTION

### Illustrative Operating Environment

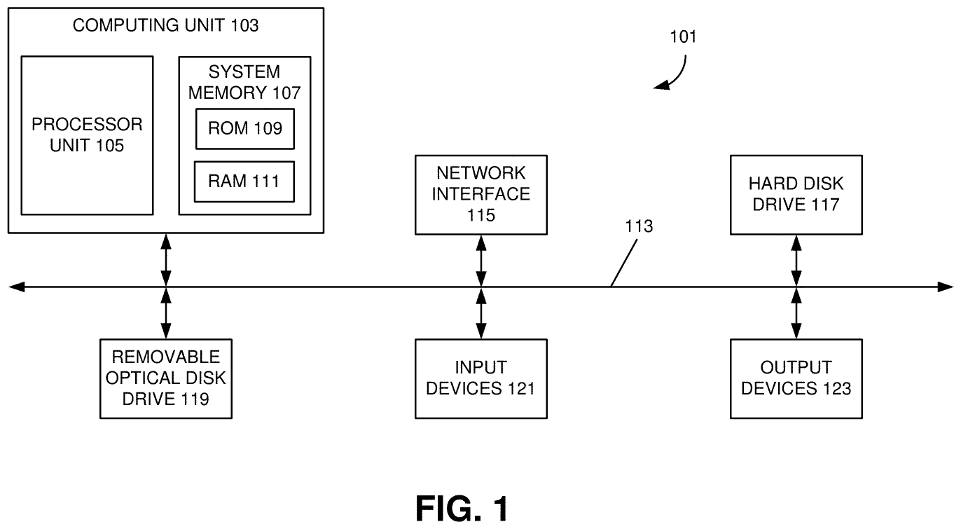

Various embodiments may be implemented through the execution of software instructions by a computing device 101, such as a programmable computer. Accordingly, FIG. 1 shows an illustrative example of a computing device 101. As seen in this figure, the computing device 101 includes a computing unit 103 with a processing unit 105 and a system memory 107. The processing unit 105 may be any type of programmable electronic device for executing software instructions, but will conventionally be a microprocessor. The system memory 107 may include both a read-only memory (ROM) 109 and a random access memory (RAM) 111. As will be appreciated by those of ordinary skill in the art, both the read-only memory (ROM) 109 and the random access memory (RAM) 111 may store software instructions for execution by the processing unit 105.

The processing unit 105 and the system memory 107 are connected, either directly or indirectly, through a bus 113 or alternate communication structure, to one or more peripheral devices 117-123. For example, the processing unit 105 or the system memory 107 may be directly or indirectly connected to one or more additional memory storage devices, such as a hard disk drive 117, which can be magnetic and/or removable, a removable optical disk drive 119, and/or a flash memory card. The processing unit 105 and the system memory 107 also may be directly or indirectly connected to one or more input devices 121 and one or more output devices 123. The input devices 121 may include, for example, a keyboard, a pointing device (such as a mouse, touchpad, stylus, trackball, or joystick), a scanner, a camera, and a microphone. The output devices 123 may include, for example, a monitor display, a printer and speakers. With various examples of the computing device 101, one or more of the peripheral devices 117-123 may be internally housed with the computing unit 103. Alternately, one or more of the peripheral devices 117-123 may be external to the housing for the computing unit 103 and connected to the bus 113 through, for example, a Universal Serial Bus (USB) connection.

With some implementations, the computing unit 103 may be directly or indirectly connected to a network interface 115 for communicating with other devices making up a network. The network interface 115 can translate data and control signals from the computing unit 103 into network messages according to one or more communication protocols, such as the transmission control protocol (TCP) and the Internet protocol (IP). Also, the network interface 115 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computing device 101 is illustrated as an example only, and it not intended to be limiting. Various embodiments may be implemented using one or more computing devices that include the components of the computing device 101 illustrated in FIG. 1, which include only a subset of the components illustrated in FIG. 1, or which include an alternate combination of components, including components that are not shown in FIG. 1. For example, various embodiments may be implemented using a multi-processor computer, a plurality of single and/or multiprocessor computers arranged into a network, or some combination of both.

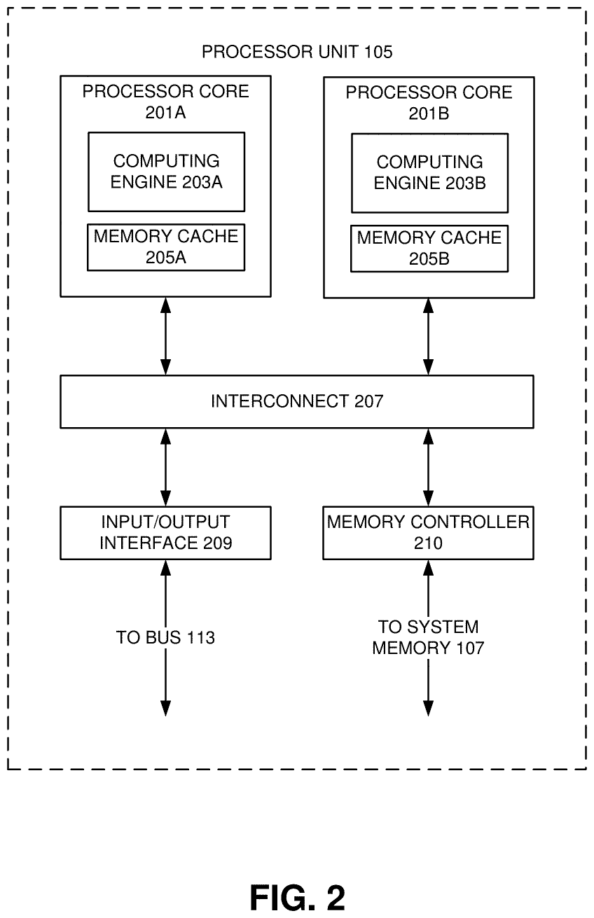

With some implementations, the processor unit 105 can have more than one processor core. Accordingly, FIG. 2 illustrates an example of a multi-core processor unit 105 that may be employed with various embodiments. As seen in this figure, the processor unit 105 includes a plurality of processor cores 201A and 201B. Each processor core 201A and 201B includes a computing engine 203A and 203B, respectively, and a memory cache 205A and 205B, respectively. As known to those of ordinary skill in the art, a computing engine 203A and 203B can include logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203A and 203B may then use its corresponding memory cache 205A and 205B, respectively, to quickly store and retrieve data and/or instructions for execution.

Each processor core 201A and 201B is connected to an interconnect 207. The particular construction of the interconnect 207 may vary depending upon the architecture of the processor unit 105. With some processor cores 201A and 201B, such as the Cell microprocessor created by Sony Corporation, Toshiba Corporation and IBM Corporation, the interconnect 207 may be implemented as an interconnect bus. With other processor units 201A and 201B, however, such as the Opteron™ and Athlon™ dual-core processors available from Advanced Micro Devices of Sunnyvale, Calif., the interconnect 207 may be implemented as a system request interface device. In any case, the processor cores 201A and 201B communicate through the interconnect 207 with an input/output interface 209 and a memory controller 210. The input/output interface 209 provides a communication interface to the bus 113. Similarly, the memory controller 210 controls the exchange of information to the system memory 107. With some implementations, the processor unit 105 may include additional components, such as a high-level cache memory accessible shared by the processor cores 201A and 201B. It also should be appreciated that the description of the computer network illustrated in FIG. 1 and FIG. 2 is provided as an example only, and it not intended to suggest any limitation as to the scope of use or functionality of alternate embodiments.

### Example Verification Environment

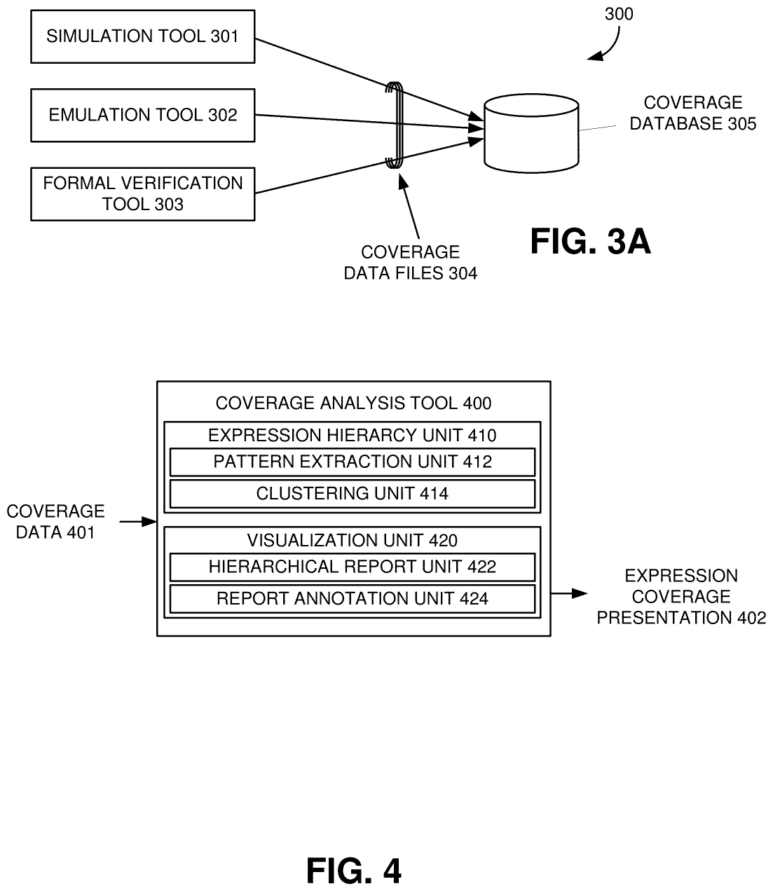

FIGS. 3A and 3B illustrate an example coverage data system 300 storing coverage data from multiple verification tools that may be implemented according to various embodiments. Referring to FIG. 3A, the coverage data system 300 can include multiple verification tools, such as a simulation tool 301, an emulation tool 302, a formal verification tool 303, or the like, to functionally verify an electronic design described by a circuit design and generate coverage data files 304 for storage in a coverage database 305. In some embodiments, the circuit design can describe the electronic device both in terms of an exchange of data signals between components in the electronic device, such as hardware registers, flip-flops, combinational logic, or the like, and in terms of logical operations that can be performed on the data signals in the electronic device. The circuit design can model the electronic device at a register transfer level (RTL), for example, with code in a hardware description language (HDL), such as Very high speed integrated circuit Hardware Design Language (VHDL), System C, or the like. In some embodiments, the verification tools can receive the circuit design from a source external to the verification tools, such as a user interface of the computer network 101, another tool implemented by the computer network 101, or one or more of the verification tools may generate the circuit design internally.

The simulation tool 301 and the emulation tool 302 can respectively simulate or emulate a test bench and a design under verification, such as the circuit design. The emulation tool 302 can perform functional verification with one or more hardware emulators configured to emulate the design under verification. The simulation tool 301 can implement the design verification tool with one or more processors configured to simulate the design under verification.

The test bench, during simulation or emulation, can generate test stimulus, for example, clock signals, activation signals, power signals, control signals, and data signals that, when grouped, may form test bench transactions capable of prompting operation of the design under verification. In some embodiments, the test bench can be written in an object-oriented programming language, for example, SystemVerilog or the like, which, when executed during elaboration, can dynamically generate test bench components for verification of the circuit design. A methodology library, for example, a Universal Verification Methodology (UVM) library, an Open Verification Methodology (OVM) library, an Advanced Verification Methodology (AVM) library, a Verification Methodology Manual (VMM) library, or the like, can be utilized as a base for creating the test bench. The simulated or emulated design under verification, in response to the test stimuli, can generate output, which can be compared to expected output of the design under verification in response to the test stimuli by the simulation tool 301 or the emulation tool 302.

The formal verification tool 303 can analyze the circuit design in an attempt to functionally verify portions of the circuit design. In some embodiments, the formal verification tool 303 can utilize one or more formal techniques, such as a Binary Decision Diagram (BDD), a Boolean Satisfiability (SAT) Solver, an Automatic Test Pattern Generator (ATPG), Cut Point Prover, or the like, in an attempt to prove or disprove functionality of circuit design. The formal verification tool 303 also can utilize static design checking functionality, such as a clock domain crossing check, a reset domain check, a power domain check, or the like, which can be utilized in an attempt to functionally verify portions of the circuit design.

The design verification tools also can record coverage events that occurred during simulation, emulation, or the like, which can identify how well the test stimulus exercised the functionality of the circuit design. For example, the verification tools can record information, such as a hierarchy of the design under verification, a test plan that includes the test bench or other test information, results of the verification operations, and coverage information, such as code coverage or functional coverage. The coverage information can identify how well verification operations, such as simulation, emulation, and/or formal verification, came to covering or adequately exercising the circuit design under verification. In some embodiments, code coverage, such as statement coverage, branch coverage, decision coverage, condition coverage, expression coverage, toggle coverage, or the like, can identify which lines, statements, expressions, decisions, or toggles of the circuit design were exercised by the test bench during verification operations, while functional coverage can quantify how well a circuit design had its functionality exercised during verification operations.

The design verification tools can utilize the recorded information to generate coverage data files 304 that can conform to a coverage data model. In some embodiments, the coverage data files 304 generated by the design verification tools can be compliant with a Unified Coverage Interoperability Standard (UCIS), which defines features a coverage data model is to include in order to be standard-compatible. The design verification tools can store the coverage data files 304 into a coverage database 305. In some embodiments, the coverage database 305 can be compliant with the UCIS, meaning it supports coverage data files 304 having standard-compatible coverage data models.

Referring to FIG. 3B, an example of the coverage data file 304 is shown. The coverage data file can include multiple sections, including a design and coverage section 310, a test plan section 320, and a test records and historical data section 330. The design and coverage design section 310 can include data corresponding to a design under verification, such as a hierarchical representation of the circuit design having undergone verification operations by the multiple design verification tools. The design and coverage design section 310 also can include data corresponding to coverage of the circuit design during the verification operations. The test plan section 320 can include information associated with one or more test plans of the verification operations. The test records and historical data section 330 can include information on tests or regressions run on the circuit design during the verification operations. Data from the sections 310-330 can be linked to each other in the coverage database 305.

The coverage portion of the design and coverage design section 310 can be structured or arranged hierarchically according to the UCIS, for example, having basic building blocks of scopes and cover points. An example of the coverage portion of the design and coverage design section 310 can include multiple cover points, such as statement cover points 313 and 315, and bin cover points 318 and 319. The UCIS cover points can be constructs having an integral count annotated with information, such as name, type, attributes, or the like, corresponding to what was counted. The cover points 313, 315, 318, and 319 can be organized by a hierarchy of scopes. In this example, the coverage portion of the design and coverage design section 310 can include a top scope 311 having two child scopes 312 and 314 and a covergroup scope 316. The child scope 312 can have the statement cover point 313, while child scope 314 can have cover point 315. The covergroup scope 316 can have another scope below it in the hierarchy of scopes, namely, a cover point scope 317. The cover point scope 317 can have bin cover points 318 and 319.

### Hierarchical Coverage Clustering for Design Verification

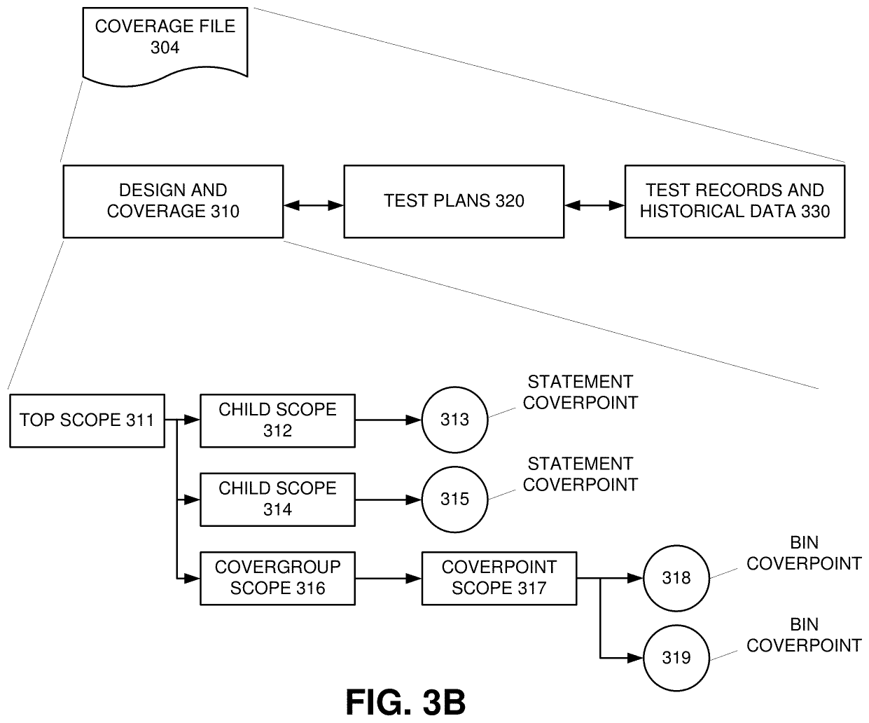

FIG. 4 illustrates an example coverage analysis tool 400 to generate an extracted pattern hierarchy from coverage data 401 recorded during circuit design verification, which may be implemented according to various embodiments. Referring to FIG. 4, the coverage analysis tool 400 can receive coverage data 401, such as one or more coverage data files, for example, stored in a coverage database. The coverage data 401 can include records of coverage events, which occurred during simulation, emulation, or the like of a circuit design. The coverage analysis tool 400 can generate a hierarchical representation of expressions or conditions in the circuit design, and then generate an expression coverage presentation 402 that correlates the coverage data 401 to expressions in the circuit design based on the generated hierarchical representation of expressions or conditions in the circuit design. The expression coverage presentation 402 can annunciate holes or gaps in coverage events corresponding to functionality in the circuit design unexercised.

The coverage analysis tool 400 can include an expression hierarchy unit 410 to generate the hierarchical representation of expressions or conditions in the circuit design from the coverage data 401. The expression hierarchy unit 410 can include a pattern extraction unit 412 to utilize the coverage data 401 to identify expressions capable of being covered during verification of the circuit design. The pattern extraction unit 412 can detect patterns between subsets of the expressions, for example, based on a Levenshtein distance similarity measure. In some embodiments, the pattern extraction unit 412 can convert the expressions identified from the coverage data 401 into an expression tree having operators as branch nodes and terminals as leaf nodes. The pattern extraction unit 412 also can normalize and pre-order the expression trees corresponding to the expressions. The pattern extraction unit 412 can compare the expression trees to detect patterns between a subset of the expression trees, and then correlate the detected patterns in the subset of the expression trees to their corresponding expressions.

The expression hierarchy unit 410 can include a clustering unit 414 to receive an indication of a detected pattern in the expressions from the pattern extraction unit 412 and generate a merged expression from the expressions having the detected pattern. In some embodiments, the clustering unit 414 can generate the merged expression by incorporating portions of the expressions having a same operator or terminal into the merged expression, and by replacing the portions of the expressions having a different operator or terminal with a “wild card” or variable terminal. The “wild card” or variable terminal can correspond to multiple different terminals with an expression.

The clustering unit 414 can output the merged expression back to the pattern extraction unit 412, which the pattern extraction unit 412 can add to the expressions. In some embodiments, the pattern extraction unit 412 can replace the expression associated with the detected pattern with the merged expression. The pattern extraction unit 412 can convert the merged expression into a merged expression tree having operators as branch nodes and terminals, including the wild card terminal, as leaf nodes. The pattern extraction unit 412 also can normalize and pre-order the merged expression tree for use in subsequent pattern detection among a group including the expressions and the merged expression.

The expression hierarchy unit 410 can iteratively detect patterns between expressions, merged expressions, or a combination thereof, and generate additional merged expressions based on the detected patterns. When the pattern extraction unit 412 can no longer detect a pattern between expressions, merged expressions, or a combination thereof, the expression hierarchy unit 410 can generate hierarchical representation of expressions or conditions in the circuit design, which can include the merge expressions and the expressions organized based on how the expressions were merged by the expression hierarchy unit 410.

The coverage analysis tool 400 can include a visualization unit 420 to generate an expression coverage presentation 402 based on the hierarchical representation of expressions or conditions in the circuit design, which can be displayed, for example, by the computing device 101. The expression coverage presentation 402 can include a list of expressions in the circuit design along an identification of coverage events for the expression from the coverage data 401.

The visualization unit 420 can include a hierarchical report unit 422 to organize the expression coverage presentation 402 based on the hierarchical representation of the expressions. For example, the hierarchical report unit 422 can include the merged expressions from the hierarchical representation of the expressions in the list of the expressions and group the merged expressions with the expressions in the circuit design that were utilized to generate the merged expressions. In some embodiments, the hierarchical report unit 422 can identify coverage data correlated to the expressions in the circuit design that were utilized to generate the merged expressions, aggregate the identified coverage data, and populate the expression coverage presentation 402 with the aggregated coverage data corresponding to the merged expressions. The addition of the merged expressions in the expression coverage presentation 402 can annunciate coverage for a group of expressions as well as identify how the group of expressions are related, for example, which terminals and/or operators the expressions have in common.

The visualization unit 420 can include a report annotation unit 424 to modify the expression coverage presentation 402 based on the hierarchical representation of the expressions. For example, the hierarchical report unit 422 can add indicators to the expressions in the expression coverage presentation 402 corresponding to the merged expressions from the hierarchical representation of the expressions. The indicators can annunciate which expressions have related expressions in the expression coverage report 402, annunciate how the expressions are related, or the like. By organizing or annotating the expression coverage presentation 402 based on the hierarchical representation of the expressions, the visualization unit 420 can identify groups of related expressions that have been covered or have been mostly covered by prior verification operations and groups of related expressions that have not been covered or have been lightly covered by prior verification operations, which can be utilized to generate new sets of test vectors for subsequent verification operations and to expedite manual expression exclusion. The efficiency of directing test vectors towards groups of previously uncovered expressions or excluding groups of expressions can reduce overall run-time by speeding up simulation-based or emulation-based verification operations and reducing utilization of formal verification to gain expression or condition coverage closure.

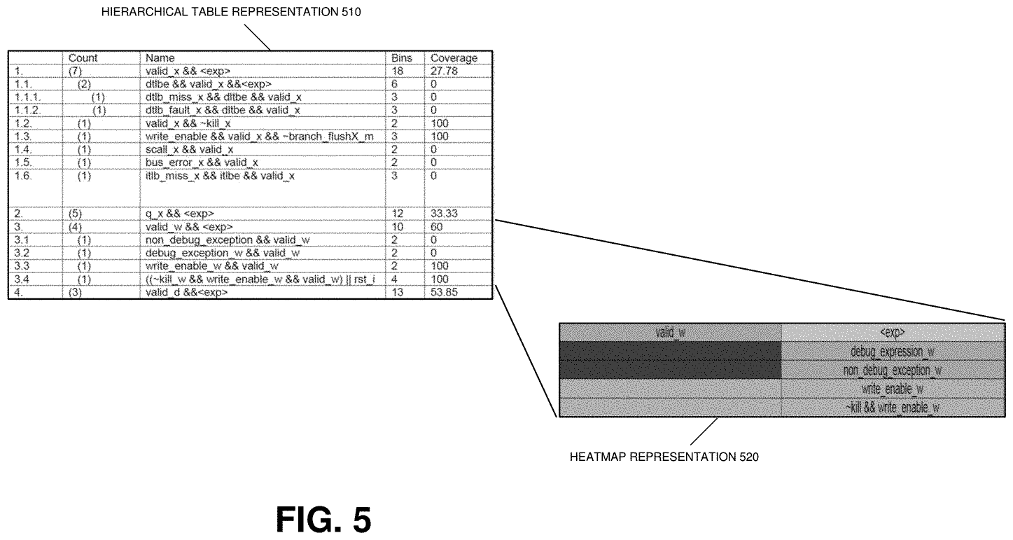

FIG. 5 illustrates an example expression coverage presentation based on an extracted pattern expression hierarchy which may be implemented according to various embodiments. Referring to FIG. 5, the expression coverage presentation can include a hierarchal table representation 510 of the extracted pattern expression hierarchy. The hierarchal table representation 510 can have a row-column format, where the rows correspond to a particular expression, bin within an expression, or a merged expression. The columns in the hierarchal table representation 510 can include information about the expression or merged expression, such as a listing of the expression under the name column, column for a number of bins associated with the expression or merged expression, column to present a percent covered for the expression or the merged expression. The hierarchal table representation 510 also can include a column to describe a hierarchy among the expressions and merged expressions, for example, providing a numbering system that indicates where in the hierarchy the expressions and merged expressions reside.

The expression coverage presentation also can include a heat map representation 520 of the extracted pattern, which can be presented in a row-column format. The rows correspond to different expressions, and the columns can be populated with the terminals available in the selected pattern for a merged expression. The heat map representation 520 also can annunciate a percent covered, for example, via a color or shading of the each intersection of the rows and columns.

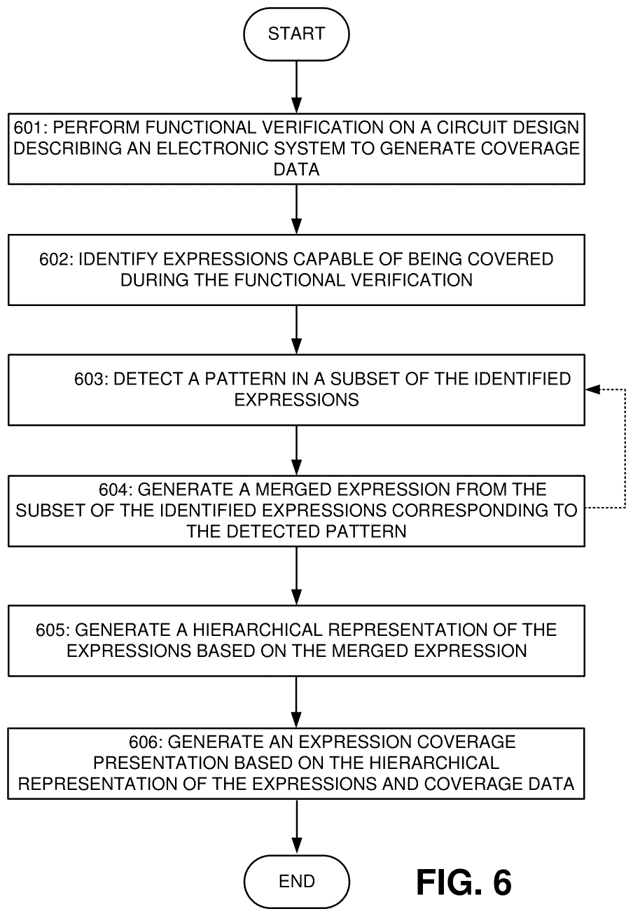

FIG. 6 illustrates an example flowchart implementing extracted pattern hierarchy generation from coverage data recorded during circuit design verification which may be implemented according to various embodiments. Referring to FIG. 6, in a block 601, a design verification system can perform functional verification on a circuit design describing an electronic system. In some embodiments, the design verification system can include multiple verification tools, such as a simulator, an emulator, a formal verification tool, or the like, to functionally verify the electronic design described by the circuit design. The design verification system can record coverage events that occurred during simulation, emulation, or the like, which can identify how well test stimulus exercised the functionality of the circuit design during the functional verification. Some of the recorded coverage events can correspond to covergroups, which can be a group of coverpoints, such as states of signals or values of variables in the circuit design under verification, and a group of coverage crosses, which can be a combination of two or more coverpoints occurring concurrently.

In a block 602, the computing system implementing a coverage analysis tool can identify expressions capable of being covered during the functional verification. In some embodiments, the computing system implementing the coverage analysis tool can parse the coverage data to locate the expressions in the circuit design having corresponding coverage bins.

In a block 603, the computing system implementing the coverage analysis tool can detect a pattern in a subset of the identified expressions. In some embodiments, the computing system implementing the coverage analysis tool can detect patterns between subsets of the expressions, for example, based on a Levenshtein distance similarity measure. For example, the computing system can convert each expression identified from the coverage data into a separate expression tree having operators as branch nodes and terminals as leaf nodes. The computing system also can normalize and pre-order the expression trees corresponding to the expressions. The computing system can compare the expression trees to detect patterns between a subset of the expression trees, and then correlate the detected patterns in the subset of the expression trees to their corresponding expressions.

In a block 604, the computing system implementing the coverage analysis tool can generate a merged expression from the subset of the identified expressions corresponding to the detected pattern. In some embodiments, the computing system can generate the merged expression by incorporating portions of the expressions having a same operator or terminal into the merged expression, and by replacing the portions of the expressions having a different operator or terminal with a “wild card” or variable terminal. The “wild card” or variable terminal can correspond to multiple different terminals with an expression. The computing system can convert the merged expression into a merged expression tree having operators as branch nodes and terminals, including the wild card terminal, as leaf nodes. The computing system also can normalize and pre-order the merged expression tree for use in subsequent pattern detection among a group including the expressions and the merged expression.

In some embodiments, the computing system can add the merged expression in with the expressions and, in some examples, replace the expressions corresponding to the detected pattern with the merged expression. The computing system can attempt to detect another pattern in the group including the expressions and the merged expression. When the computing system detects another pattern, execution proceeds back to block 603, and the computing system can generate another merged expression based on the pattern.

When the computing system does not detect another pattern, execution can proceed to a block 605, where the computing system implementing the coverage analysis tool can generate a hierarchical representation of the expressions based on the merged expressions. The hierarchical representation of expressions in the circuit design can include the merged expressions and the expressions organized based on how the expressions were merged.

In a block 606, the computing system implementing the coverage analysis tool can generate an expression coverage presentation based on the hierarchical representation of the expressions and coverage data. The expression coverage presentation can include a list of expressions in the circuit design along an identification of coverage events for the expression from the coverage data. The computing system can organize the expression coverage presentation based on the hierarchical representation of the expressions, for example, by including the merged expressions from the hierarchical representation of the expressions in the list of the expressions and by grouping the merged expressions with the expressions in the circuit design that were utilized to generate the merged expressions.

In some embodiments, the computing system can identify coverage data correlated to the expressions in the circuit design that were utilized to generate the merged expressions, aggregate the identified coverage data, and populate the expression coverage presentation with the aggregated coverage data corresponding to the merged expressions. The addition of the merged expressions in the expression coverage presentation can annunciate coverage for a group of expressions as well as identify how expressions are related in the group, for example, which terminals and/or operators the expressions have in common. In some embodiments, the computing system can generate the expression coverage presentation as a list of the expressions with added indicators that can annunciate which of the expressions have related expressions in the expression coverage report, annunciate how the expressions are related, or the like.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing device may execute instructions or “code” stored in memory. The memory may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a known rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

### CONCLUSION

While the application describes specific examples of carrying out embodiments, those skilled in the art will appreciate that there are numerous variations and permutations of the above described systems and techniques that fall within the spirit and scope of the invention as set forth in the appended claims. For example, while some of the specific terminology has been employed above to refer to electronic design automation processes, it should be appreciated that various examples may be implemented using any electronic system.

One of skill in the art will also recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. A method comprising:
performing functional verification on a circuit design describing an electronic device to generate coverage data;
detecting, by a computing system, a pattern in a subset of expressions within the circuit design;
generating, by the computing system, a merged expression from the subset of the identified expressions corresponding to the detected pattern; and
generating, by the computing system, an expression coverage presentation based on the merged expression and the coverage data.

2. The method of claim 1, further comprising generating, by the computing system, a hierarchical representation of the expressions based, at least in part, on the merged expression.

3. The method of claim 2, further comprising correlating, by the computing system, the coverage data corresponding to the subset of the identified expressions to the merged expression.

4. The method of claim 1, further comprising:
detecting, by the computing system, a pattern between the merged expression and at least another one of the expressions; and
generating, by the computing system, another merged expression from the merged expression and at least another one of the expressions corresponding to the detected pattern.

5. The method of claim 1, wherein generating the expression coverage presentation further comprises:
incorporating the merged expression into the expression coverage presentation; and
organizing the expressions and the merged expression in the expression coverage presentation by grouping the subset of the expressions utilized to generate the merged expression in the expression coverage presentation.

6. The method of claim 1, wherein generating the expression coverage presentation further comprises adding indicators to the expression coverage presentation, which annunciate that the subset of the expressions utilized to generate the merged expression.

7. The method of claim 1, wherein performing functional verification on the circuit design describing the electronic device further comprises:
generating test stimulus to provide to the electronic device modeled in a verification environment based on the circuit design; and
recording when expressions were performed in the verification environment by the electronic device in response to the test stimulus as coverage data for the expressions.

8. An apparatus comprising at least one computer-readable memory device storing instructions configured to cause one or more processing devices to perform operations comprising:
detecting a pattern in a subset of expressions within a circuit design describing an electronic device;
generating a merged expression from the subset of the identified expressions corresponding to the detected pattern; and
generating an expression coverage presentation based on the merged expression and the coverage data.

9. The apparatus of claim 8, wherein the instructions are configured to cause one or more processing devices to perform operations further comprising generating a hierarchical representation of the expressions based, at least in part, on the merged expression.

10. The apparatus of claim 9, herein the instructions are configured to cause one or more processing devices to perform operations further comprising correlating the coverage data corresponding to the subset of the identified expressions to the merged expression.

11. The apparatus of claim 8, further comprising:
detecting, by the computing system, a pattern between the merged expression and at least another one of the expressions; and
generating, by the computing system, another merged expression from the merged expression and at least another one of the expressions corresponding to the detected pattern.

12. The apparatus of claim 8, wherein generating the expression coverage presentation further comprises:
incorporating the merged expression into the expression coverage presentation; and
organizing the expressions and the merged expression in the expression coverage presentation by grouping the subset of the expressions utilized to generate the merged expression in the expression coverage presentation.

13. The apparatus of claim 8, wherein generating the expression coverage presentation further comprises adding indicators to the expression coverage presentation, which annunciate that the subset of the expressions utilized to generate the merged expression.

14. The apparatus of claim 8, wherein the instructions are configured to cause one or more processing devices to perform operations further comprising performing functional verification on the circuit design describing the electronic device further comprises generating test stimulus to provide to the electronic device modeled in a verification environment based on the circuit design, and recording when expressions were performed in the verification environment by the electronic device in response to the test stimulus as coverage data for the expressions.

15. A system comprising:
a memory system configured to store computer-executable instructions; and
a computing system, in response to execution of the computer-executable instructions, is configured to:
detect a pattern in a subset of expressions within a circuit design describing an electronic device;
generate a merged expression from the subset of the identified expressions corresponding to the detected pattern; and
generate an expression coverage presentation based on the merged expression and the coverage data.

16. The system of claim 15, wherein the computing system, in response to execution of the computer-executable instructions, is further configured to generate a hierarchical representation of the expressions based, at least in part, on the merged expression.

17. The system of claim 16, wherein the computing system, in response to execution of the computer-executable instructions, is further configured to correlate the coverage data corresponding to the subset of the identified expressions to the merged expression.

18. The system of claim 15, wherein the computing system, in response to execution of the computer-executable instructions, is further configured to:
detect a pattern between the merged expression and at least another one of the expressions or another merged expression; and
generate another merged expression from the merged expression and at least another one of the expressions corresponding to the detected pattern.

19. The system of claim 15, wherein the computing system, in response to execution of the computer-executable instructions, is further configured to generate the expression coverage presentation by incorporating the merged expression into the expression coverage presentation, and organizing the expressions and the merged expression in the expression coverage presentation by grouping the subset of the expressions utilized to generate the merged expression in the expression coverage presentation.

20. The system of claim 15, wherein the computing system, in response to execution of the computer-executable instructions, is further configured to generate the expression coverage presentation by adding indicators to the expression coverage presentation, which annunciate that the subset of the expressions utilized to generate the merged expression.
